(19) United States
(12) Patent Application Publication
(10) Pub. No.: US 2025/0056536 A1
(43) Pub. Date: Feb. 13, 2025

(54) WIRELESS COMMUNICATION METHOD AND DEVICE THEREOF

(71) Applicant: ZTE CORPORATION, Shenzhen (CN)

(72) Inventors: Jiajun XU, Shenzhen (CN); Jun XU, Shenzhen (CN); Hong TANG, Shenzhen (CN); Mengzhu CHEN, Shenzhen (CN); Bo DAI, Shenzhen (CN); Jianqiang DAI, Shenzhen (CN); Xiaoying MA, Shenzhen (CN)

(73) Assignee: ZTE CORPORATION, Shenzhen (CN)

(21) Appl. No.: 18/933,705

(22) Filed: Oct. 31, 2024

Related U.S. Application Data
(63) Continuation of application No. PCT/CN2022/130146, filed on Nov. 4, 2022.

(51) Int. Cl. H04W 72/1268; H04W 72/21

(52) U.S. Cl. CPC H04W 72/1268; H04W 72/21

(57) ABSTRACT

A wireless communication method for use in a wireless terminal is disclosed. The method comprises receiving, from a wireless network node, a first signaling comprising a first configuration signaling, wherein the first configuration signaling is used to configure a first resource set for a configured grant (CG) transmission, and transmitting, to the wireless network node, a second signaling associated with a first transmission resource set on a second transmission resource set, wherein the first resource set includes the first transmission resource set.

### CROSS-REFERENCE TO RELATED APPLICATION

This application claims the benefit of priority under 35 U.S.C. § 120 as a continuation of International Patent Application No. PCT/CN2022/130146, filed on Nov. 4, 2022, the disclosure of which is incorporated herein by reference in its entirety.

### TECHNICAL FIELD

This document is directed generally to wireless communications, and in particular to 5G communications.

### BACKGROUND

In beyond 5G and 6G communications, one of promising services (e.g., extended reality (XR) service) is characterized by quasi-periodicity (jitter impact), large and various data amount and stringent latency requirement. In the existing arts, configured grant (CG) is capable of conveying periodic data by using preconfigured resources without a grant request and extra resource granted delay. However, owing to the service characteristics of large and various data amount, the preconfigured resources may be overly configured, resulting in resource waste and therefore low resource efficiency.

### SUMMARY

This document relates to methods and devices associated with a hybrid semi-static and dynamic configuration, and in particular to methods and devices associated with a hybrid semi-static and dynamic configuration for conveying periodic data.

The present disclosure relates to a wireless communication method for use in a wireless terminal. The method comprises:
receiving, from a wireless network node, a first signaling comprising a first configuration signaling, wherein the first configuration signaling is used to configure a first resource set for a configured grant (CG) transmission, and
transmitting, to the wireless network node, a second signaling associated with a first transmission resource set on a second transmission resource set,
wherein the first resource set includes the first transmission resource set.

The present disclosure relates to a wireless communication method for use in a wireless network node. The method comprises:
transmitting, to a wireless terminal, a first signaling comprising a first configuration signaling, wherein the first configuration signaling is used to configure a first resource set for a configured grant (CG) transmission, and
receiving, from the wireless terminal, a second signaling associated with a first transmission resource set on a second transmission resource set,
wherein the first resource set includes the first transmission resource set.

Various embodiments may preferably implement the following features:

Preferably or in some embodiments, the first transmission resource set is a part of first resource set or a subset of first resource set.

Preferably or in some embodiments, resources in the first resource set are periodic.

Preferably or in some embodiments, the second transmission resource set is included in the second resource set and the second resource set is configured by a second configuration signaling in the first signaling.

Preferably or in some embodiments, the second transmission resource set is a part of second resource set or a subset of the second resource set.

Preferably or in some embodiments, the second configuration signaling comprises at least one of periodicity information for the second resource set, offset information for the second resource set, a resource identifier for the second resource set, a maximum transmission time for the second signaling, a prohibit timer for the second signaling.

Preferably or in some embodiments, resources in the second resource set are periodic.

Preferably or in some embodiments, a periodicity of the resources in the second resource set is configured by periodicity information in the second configuration signaling.

Preferably or in some embodiments, a periodicity of the resources in the second resource set is the same with a periodicity of the resources in the first resource set.

Preferably or in some embodiments, the second resource set is associated with the first resource set.

Preferably or in some embodiments, one or more resources in the second resource set are located an offset before or after a resource in the first resource set.

Preferably or in some embodiments, a unit of the offset is a slot, a symbol or a radio frame.

Preferably or in some embodiments, one or more resources in the second resource set are in the same slot as a resource in the first resource set.

Preferably or in some embodiments, one or more resources in the second resource set are an offset before or after the resource in the first resource set.

Preferably or in some embodiments, a unit of the offset is a symbol.

Preferably or in some embodiments, the offset is determined based on offset information in the second configuration signaling.

Preferably or in some embodiments, the resources in the first resource set include at least one of:
a first resource in the resources associated with the first resource set,
a last resource in the resources associated with the first resource set, or
a plurality of resources in the first resource set in one or more durations

Preferably or in some embodiments, the first transmission resource set includes one or more resources in the first resource set unused for the CG transmission in one or more durations.

Preferably or in some embodiments, the first transmission resource set includes one or more resources in the first resource set used for the CG transmission in one or more durations.

Preferably or in some embodiments, the first transmission resource set includes one or more resources in the first resource set valid for the CG transmission in one or more durations.

Preferably or in some embodiments, the first transmission resource set includes one or more resources in the first resource set invalid for the CG transmission in one or more durations.

Preferably or in some embodiments, the first configuration signaling configures the first resource set by configuring single resource in a duration or a plurality of resources in a duration.

Preferably or in some embodiments, the duration is at least one of a length of symbols for the CG transmission, a length of slots for the CG transmission, a length of radio frames for the CG transmission.

Preferably or in some embodiments, the duration is determined by at least one of: a radio resource control (RRC) signaling, a media access control (MAC) control element (CE) signaling and DCI signaling.

Preferably or in some embodiments, the first configuration signaling configures the first resource set by configuring the plurality of resources in the duration and the plurality of resources are determined by a CG configuration.

Preferably or in some embodiments, the first configuration signaling configures the first resource set by configuring the plurality of resources in the duration, and the plurality of resources are determined by one or more CG configurations.

Preferably or in some embodiments, the second signaling includes at least one of an uplink MAC CE or an uplink control information (UCI) signaling.

Preferably or in some embodiments, the second signaling comprises resource information and the resource information comprises a number of resources in the first transmission resource set in one or more durations.

Preferably or in some embodiments, the second signaling comprises resource information, wherein the resource information comprises at least one of an indication for a starting resource in the first transmission resource set in one or more durations, or an indication for an ending resource in the first transmission resource set in one or more durations.

Preferably or in some embodiments, the second signaling comprises resource information, wherein the resource information comprises a bitmap for indicating resources in the first transmission resource set or in the first resource set in one or more durations.

Preferably or in some embodiments, the second signaling comprises resource information, and wherein the resource information comprises a Start and Length Indicator (SLIV) for the first transmission resources set in one or more durations.

Preferably or in some embodiments, the second signaling comprises resource information, and wherein the resource information comprises a resource block number of the last resource in the first transmission resource set in one or more durations.

Preferably or in some embodiments, the second signaling further indicates at least one of:
a number of consecutive resources in the first transmission resource set in one or more durations,
a first resource in the first transmission resource set in one or more durations, or
one or more resources in the first transmission resource set in one or more durations.

Preferably or in some embodiments, the second signaling is associated with one or more durations, wherein the one or more durations start before or after the second signaling is transmitted.

Preferably or in some embodiments, the second signaling indicate resource information in a current duration.

Preferably or in some embodiments, the second signaling is transmitted in the second transmission resource set by a physical uplink control channel (PUCCH) or a physical uplink shared channel (PUSCH).

Preferably or in some embodiments, the second signaling is transmitted in the second transmission resource set by the PUCCH, and wherein the PUCCH is located an offset before or after a resource in the first transmission resource set.

Preferably or in some embodiments, a unit of the offset is a slot, a symbol or a radio frame.
Preferably or in some embodiments, the second signaling is transmitted in the second transmission resource set by the PUCCH, wherein the PUCCH is located in the same slot as a resource in the first transmission resource set, and an offset before or after a resource in first transmission resource set.
Preferably or in some embodiments, a unit of the offset is a symbol.

Preferably or in some embodiments, resources in the first transmission resource set include at least one of:
a first resource in the resources associated with the first transmission resource set,
a last resource in the resources associated with the first transmission resource set, or
a plurality of resources in the first transmission resource set in one or more durations.

Preferably or in some embodiments, the resource in the first transmission resource set includes at least one of:
a P-th resource of the first transmission resource set, or
a plurality of resources in one or more durations of the first resource set,
wherein P is a positive integer.

Preferably or in some embodiments, the second signaling is transmitted on the PUCCH and wherein resource information associated with the first transmission resource set carried by the second signaling is determined by at least one of:
cyclic shift information,
an orthogonal cover code, or
a high layer parameter.

Preferably or in some embodiments, the second signaling is transmitted in the second transmission resource set by the PUSCH.

Preferably or in some embodiments, resource elements of the PUSCH start at a starting point and according to first an order in a frequency domain and then an order in time domain.

Preferably or in some embodiments, resource elements of the PUSCH start at a starting point and according to first an order in time domain and then an order in frequency domain.

Preferably or in some embodiments, the second signaling is transmitted in the second transmission resource set by the PUSCH, wherein a starting point of the PUSCH is determined by at least one of the first resource element in the first symbol, the first resource element in the last symbol, the last resource element in the first symbol or the last resource element in the last symbol in the PUSCH.
Preferably or in some embodiments, the second signaling is transmitted in the second transmission resource set by the PUSCH, wherein the PUSCH includes at least one of:
   a Q-th resource of the first transmission resource set,
   a R-th resource of the first resource set,
   a plurality of resources of the first transmission resource set, or
   a plurality of resources of the first resource set, and
wherein Q and R are positive integers.

The present disclosure relates to a wireless terminal. The wireless terminal comprises:
a communication unit, configured to:
receive, from a wireless network node, a first signaling comprising a first configuration signaling, wherein the first configuration signaling is used to configure a first resource set for a configured grant (CG) transmission, and
transmit, to the wireless network node, a second signaling associated with a first transmission resource set on a second transmission resource set,
wherein the first resource set includes the first transmission resource set.

Various embodiments may preferably implement the following feature:

Preferably or in some embodiments, the wireless terminal further comprises a processor configured to perform any of the aforementioned wireless communication methods.

The present disclosure relates to a wireless network node. The wireless network node comprises:
a communication unit, configured to:
   transmit, to a wireless terminal, a first signaling comprising a first configuration signaling, wherein the first configuration signaling is used to configure a first resource set for a configured grant (CG) transmission, and
   receive, from the wireless terminal, a second signaling associated with a first transmission resource set on a second transmission resource set,
wherein the first resource set includes the first transmission resource set.

Various embodiments may preferably implement the following feature:

Preferably or in some embodiments, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 shows a schematic diagram of a network according to an embodiment of the present disclosure.

FIG. 2 shows a schematic diagram of CG PUSCH resources according to an embodiment of the present disclosure.

FIG. 3 shows a schematic of a procedure of UCI transmission according to an embodiment of the present disclosure.

FIG. 4 shows a flowchart of a method according to an embodiment of the present disclosure.

FIGS. 5 to 33 show schematic diagrams of transmission resources according to embodiments of the present disclosure.

FIGS. 34 and 35 show schematic diagrams of resource element order/sequence according to embodiments of the present disclosure.

FIG. 36 shows a schematic diagram of starting points according to an embodiment of the present disclosure.

FIG. 37 shows an example of a schematic diagram of a wireless terminal according to an embodiment of the present disclosure.

FIG. 38 shows an example of a schematic diagram of a wireless network node according to an embodiment of the present disclosure.

FIG. 39 shows a flowchart of a method according to an embodiment of the present disclosure.

FIG. 40 shows a procedure of second signaling reporting according to an embodiment of the present disclosure.

### DETAILED DESCRIPTION

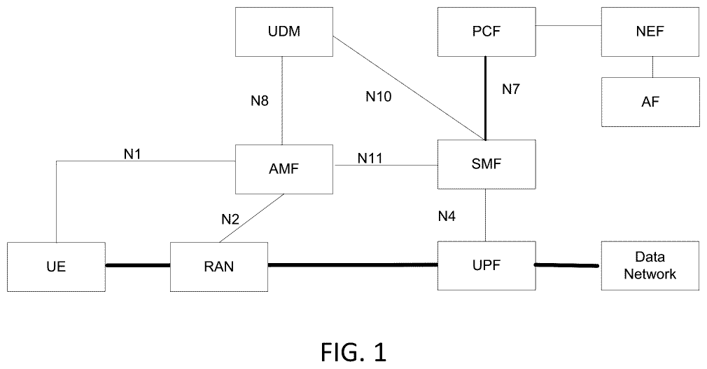

FIG. 1 shows a schematic diagram of a network (architecture) according to an embodiment of the present disclosure. In FIG. 1, the network comprises the following network functions/entities:
1) UE: User Equipment
2) RAN: Radio Access Network

In the present disclosure, the RAN may be equal to RAN node or next-generation RAN (NG-RAN) (node).
3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.
4) SMF: Session Management Function

The SMF includes the following functionalities: session establishment, modification and release, UE IP address allocation & management (including optional authorization functions), selection and control of User Plane (UP) function, downlink data notification. The SMF can subscribe the mobility related events and information from AMF.
5) UPF: User Plane Function

The UPF includes the following functionalities: serving as an anchor point for intra-/inter-radio access technology (RAT) mobility and the external session point of interconnect to Data Network, packet routing & forwarding as indicated by SMF, traffic usage reporting, quality of service (QOS) handling for the UP, downlink packet buffering and downlink data notification triggering, etc.
6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which is used for AMF to select a proper SMF. The AMF and SMF get the subscription from UDM. The subscription data is stored in the Unified Data Repository (UDR). The UDM uses such data upon reception of request from AMF or SMF.
7) PCF: Policy Control Function

The PCF supports unified policy framework to govern network behavior. The PCF provides access management policy to the AMF, or session management policy to the SMF, and/or UE policy to the UE. The PCF can access the UDR to obtain subscription information relevant for policy decisions. The PCF may also generate the policy to govern network behavior based on the subscription and indication from an application function (AF). Then, the PCF can provide policy rules to CP functions (e.g., the AMF and/or the SMF) to enforce the CP functions.
8) NEF: Network Exposure Function

The NEF supports exposure of capability and events of the network towards the AF. A third party AF can invoke the service provided by the network via the NEF and the NEF performs authentication and authorization of the third party applications. The NEF also provides translation of the information exchanged with the AF and information exchanged with the internal NF.
9) AF: Application Function

The AF interacts with the Core Network in order to provide services, e.g., to support: application influence on traffic routing, accessing the NEF, interacting with the Policy framework for policy control etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

Due to XR characteristic of large packet size, implying one CG PUSCH resource is impossible to transmit all the data in an XR packet, multiple CG PUSCH resources in a period are considered to carry the XR packet.

Meanwhile, because of XR characteristic of variable packet sizes (implying that XR packets are different in each period), there are different amounts of unused CG PUSCH resources in each period.

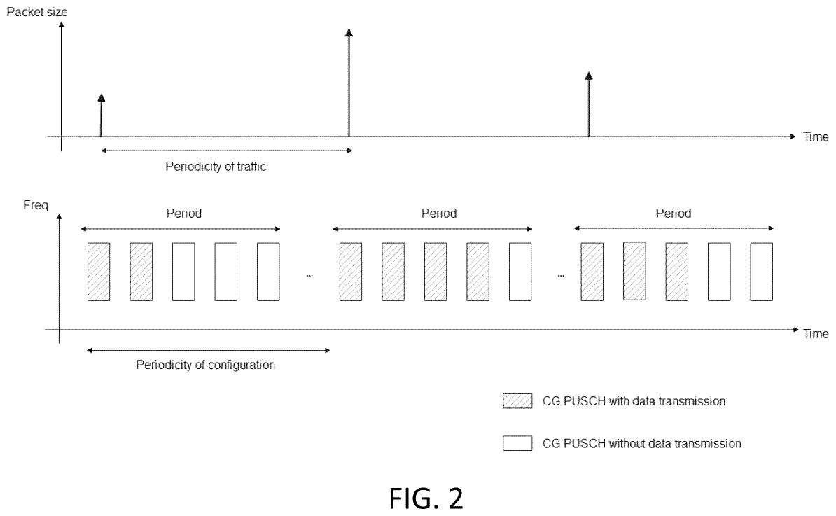

FIG. 2 shows a schematic diagram of CG PUSCH resources according to an embodiment of the present disclosure. In FIG. 2, each period is configured with 5 CG PUSCH resources for a service (e.g., XR service). In the 1^{st} period, 2 out of 5 CG PUSCH resources are used for data transmission of the service. That is 3 CG PUSCH resources are wasted. Similarly, there is 1 CG PUSCH resource in the 2^{nd} period is not used for the data transmission and there are 2 CG PUSCH resources in the 3^{rd} period is not used for the data transmission. That is there are 6 unused CG PUSCH resources in these 3 periods.

In an embodiment, a signaling (e.g., UCI signaling, MAC CE signaling) may be used for UE to indicate the unused CG PUSCH resources to the gNB. Under such a condition, the gNB may release the unused CG PUSCH resources and re-use them for another traffic transmission.

In an embodiment, uplink control information (UCI) includes hybrid automatic re-transmission request-acknowledge (HARQ-ACK) information, scheduling request (SR), channel state information (CQI) report and configured grant-uplink control information (CG-UCI). More specifically, the UCI signaling may include:
HARQ-ACK information;
SR;
CSI report;
CG-UCI;

The UCI can be transmitted in a physical uplink control channel (PUCCH) and/or a physical uplink shared channel (PUSCH). In detail, the HARQ-ACK information and the CQI report can be transmitted in both PUCCH and PUSCH, SR is able to be transmitted only in PUCCH, while CG-UCI is transmitted in only PUSCH.

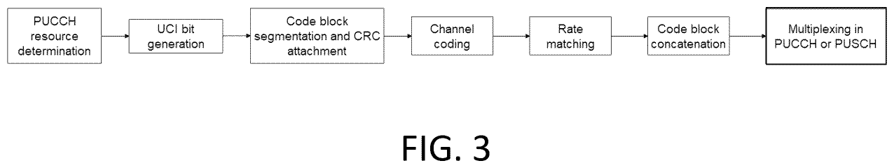

FIG. 3 shows a schematic of a procedure of UCI transmission according to an embodiment of the present disclosure. The procedure shown in FIG. 3 comprises:
PUCCH resource determination: Configuring PUCCH resources for UCI transmission.
UCI bit generation: Generating a bit stream for the UCI.
Code block segmentation and CRC attachment: Segmenting the bit stream into several code blocks and attaching a cyclic redundancy check (CRC) in each code block
Channel coding: Encoding the code blocks by using channel coding techniques, such as Polar coding and/or LDPC.
Rate matching: Enabling lengths of the code blocks to match the actual transmission capacity
Code block concatenation: concatenate the code blocks and form a coded bit stream.

In order to enhance the resource efficiency of CG configuration, the present disclosure proposes a signaling/indication (e.g., UCI signaling and/or a MAC CE signaling) for UE to indicate the unused CG PUSCH resources to the gNB.

Specifically, the following aspects would be discussed in various embodiments of the present disclosure:

A) The signaling type for this indication:
Re-use and re-interpret current UCI signaling, e.g., SR, CG-UCI, CSI report
Design a new dedicate UCI signaling
MAC CE signaling
   B) The resource configuration for the signaling transmission
Dedicated configuration signaling and relevant to the CG configuration
Dedicated configuration signaling and independent to the CG configuration
Dedicated configuration signaling and relevant to the configuration signaling for CG configuration
   C) The information carried by the signaling to express the indication
Bitmap to indicate the activated resource and the released resource
Location information for activated resources and/or the release resource
Length information for activated resources and/or the release resource
   D) The signaling transmission
Signaling can be transmitted by PUCCH and/or by PUSCH
Transmission location of PUCCH or PUSCH
Inherit the transmission procedure of legacy UCI in PUCCH and/or in PUSCH, as illustrated in FIG. 3.

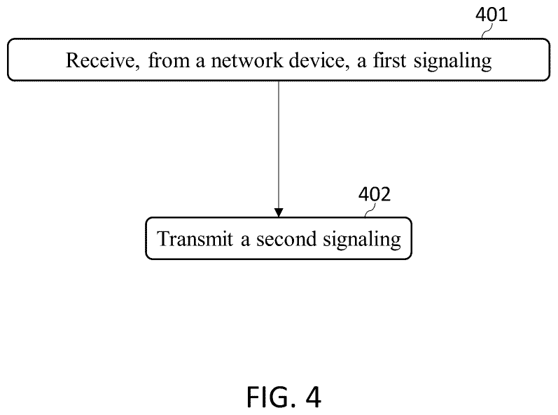

FIG. 4 shows a flowchart of a method according to an embodiment of the present disclosure. The method shown in FIG. 4 may be used in the UE and comprises the following steps:
Step 401: Receive, from a network device, a first signaling.
Step 402: Transmit a second signaling.

In FIG. 4, the UE receives a first signaling, comprising a first configuration signaling from a network device (e.g., gNB, RAN (node)). The first configuration signaling is used to configure a first resource set for a CG transmission. Based on the first signaling, the UE transmits the second signaling associated with a first transmission resource set on a second transmission resource set.

In an embodiment, the first signaling is an RRC (radio resource control) signaling, or physical uplink control channel (PUCCH) configuration.

In some cases, the PUCCH configuration is RRC signaling PUCCH-config

In an embodiment, the first configuration signaling is an RRC signaling, configured grant configuration.

In some cases, the configured grant configuration is an RRC signaling ConfiguredGrantConfig

In an embodiment, the second signaling is a UCI signaling, which may be named as resource release UCI (RR-UCI), resource recycle UCI (RR-UCI), resource reused UCI (RR-UCI), or scheduling free UCI (SF-UCI),

In an embodiment, the second signaling is a MAC CE signaling, which may be named as resource release MAC CE, resource recycle MAC CE, resource reused MAC CE, or scheduling free MAC CE.

In an embodiment, the first resource set configured by the first configuration signaling includes a plurality of CG PUSCHs and the resources in the first resource set are transmitted by the CG PUSCHs.

In some cases, the first resource set configured by the first configuration signaling includes a plurality of CG transmission occasions and the resources in the first resource set are CG transmission occasions.

In an embodiment, the resources in the first resource set are periodic.

In some cases, the resources in the first resource set are periodic means that every two consecutive/nearby/contiguous resources in the first resource set have the same interval.

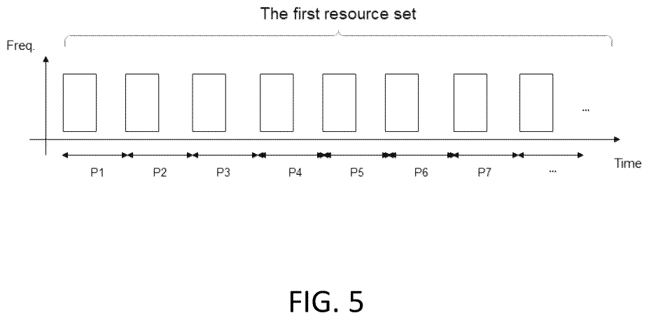

In an embodiment of FIG. 5, the interval between two consecutive/nearby/contiguous resources is expressed as Pn (where n is a positive integer) and the P1=P2=. . . =Pn, where Pn is in the unit of a symbol, a slot or a radio frame.

In some cases, the resources in the first resource set are periodic means that the resources of the first resource set in a time duration have the same interval.

In the present disclosure, the term “time duration” may be equal to “duration”.

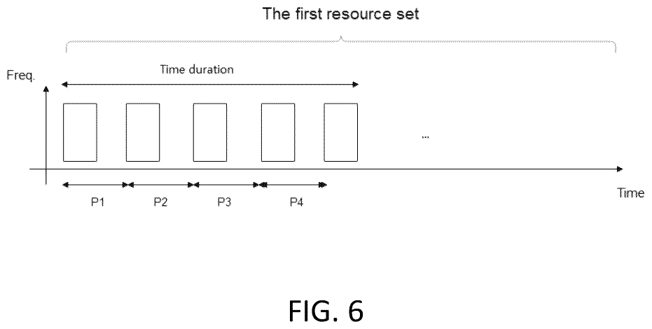

In an embodiment shown in FIG. 6, the interval of two nearby resources in a time duration is expressed as Pn (n is a positive integer) and P1=P2=. . . =Pn, where Pn is in the unit of a symbol, a slot or a radio frame.

In some cases, the resources in the first resource set are periodic means that the resources in one time duration and the resources in another subsequent time duration have the same interval.

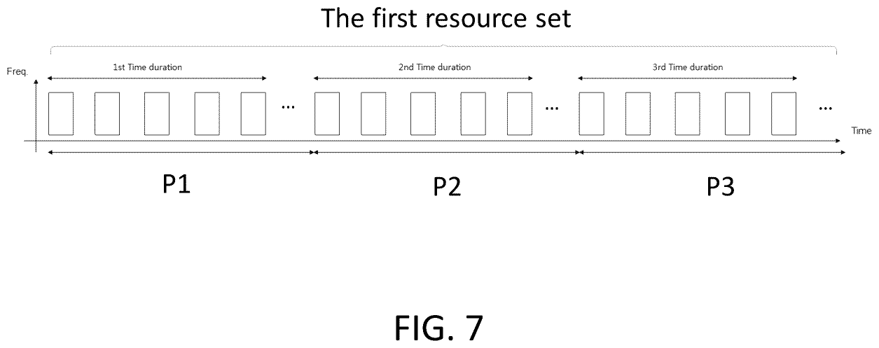

In an embodiment shown in FIG. 7, the interval of two nearby time durations is expressed as Pn (where n is a positive integer) and the P1=P2=. . . =Pn, where Pn is in the unit of a symbol, a slot or a radio frame.

In an embodiment, the first transmission resource set is a part of the first resource set or a subset of the first resource set.

In an embodiment, the first transmission resource set includes one or more resources in the first resource set unused for the CG transmission in one or more time durations.

In some cases, the one or more resources in the first resource set are unused means that one or more resources are with no data transmission.

In an embodiment, the first transmission resource set includes one or more resources in the first resource set used for the CG transmission in one or more time durations.

In some cases, the one or more resources in the first resource set are used means that one or more resources are with data transmissions.

In an embodiment, the first transmission resource set includes one or more resources in the first resource set invalid for the CG transmission in one or more time durations.

In some cases, the one or more resources in the first resource set are invalid means the invalid resources are the resources which cannot be used for data transmissions.

In an embodiment, the first transmission resource set includes one or more resources in the first resource set valid for the CG transmission in one or more time durations.

In some cases, the one or more resources in the first resource set are valid means the valid resources are the resource which can be used for data transmissions.

In an embodiment, the first transmission resource set includes one or more resources in the first resource set unused and used for the CG transmission in one or more time durations.

In an embodiment, the first transmission resource set includes one or more resources in the first resource set valid and invalid for the CG transmission in one or more time durations.

In an embodiment, the second transmission resource set is a part of a second resource set, or a subset of a second resource set, where the second resource set is configured by a second configuration signaling.

In an embodiment, the second configuration signaling is included in the first signaling.

In an embodiment, the resources in the second resource set are periodic, where the periodicity has three meanings as illustrated in FIGS. 5 to 7.

In an embodiment, the second signaling comprising at least one of a periodicity information, an offset information, a resource identifier, a maximum transmission time for the second signaling, a prohibit timer.

In some cases, the periodicity of the resources in the second resource set is configured by the periodicity information, where the periodicity is in the unit of a symbol, a slot or a radio frame.

In some cases, the offset for the resources in the second resource set is to configure a distance/difference between the resources and a benchmark/reference point, where the offset is in the unit of a symbol, a slot or a radio frame.

For example, the benchmark/reference point may be the symbol or slot location of the resources when offset is 0 or the symbol or slot location of the resources in the first resource set.

In some cases, the resource identifier is used to modify the second resource set and indicate which second resource set(s) is used.

In some cases, the maximum transmission time is used to determine the maximum number of times of performing the second signaling transmissions.

In some cases, the prohibit timer is used to determine a valid time duration for the second signaling transmission, where the prohibit timer is in the unit of a symbol, a slot, a millisecond or a radio frame.

In an embodiment, the second configuration signaling configures the second resource set by at least one of the following embodiments/cases:

A. In some embodiments, the first configuration signaling and the second configuration signaling are independent and the first resource set and the second resource set are configured separately.

In these embodiments, the second configuration signaling comprises the periodicity information, the offset information, the resource identifier, the maximum transmission time and the prohibit timer.

As an alternative, the second configuration signaling comprises the periodicity information, the offset information and the resource identifier.

As an alternative, the second configuration signaling comprises the periodicity information and the offset information.

In an embodiment, the offset information and the periodicity information are used for determining the locations of the resources in the second resource set.

For example, the location of resources for the second signaling can be determined based on:

$$( {n}_{f} \cdot {N}_{slot}^{frame , μ} + {n}_{s , f}^{μ} - {RR}_{offset} ) mod {RR}_{periodicity} = 0 , \qquad ( I )$$

where n_{f} is the identifier number of a radio frame, n_{s,f}^{u} denotes the identifier number of slot, Nₛₗₒₜ^{frame,u} denotes the number of slots in a radio frame, RR_{offset} is determined based on the offset information and RR_{periodicity} is determined based on the periodicity information.

B. In some embodiments, the first configuration signaling and the second configuration signaling are separate and the second resource set is associated with the first resource set.

In an embodiment, the association between the first resource set and the second resource set represents that the resources in the second resource set and the resources in the first resource set have the same periodicity.

In an embodiment, the second configuration signaling comprises the periodicity information, the offset information, the resource identifier, the maximum transmission time and the prohibit timer.

As an alternative, the second configuration signaling comprises the offset information, the resource identifier, the maximum transmission time and the prohibit timer.

As an alternative, the second configuration signaling comprises the periodicity information, the offset information and the resource identifier.

As an alternative, the second configuration signaling comprises the offset information and the resource identifier.

As an alternative, the second configuration signaling comprises the periodicity information and the offset information.

As an alternative, the second configuration signaling comprises the offset information.

In an embodiment, the periodicity information is used for determining the periodicity of the resources in the second resource set.

In an embodiment, the offset information is used for determining the interval between the resources in the second resource set and the resources in the first resource set.

C. In some embodiments, the first signaling comprises the first configuration signaling and the second configuration signaling and the second resource set is associated with the first resource set.

In an embodiment, the association between the first resource set and the second resource set represents that the resources in the second resource set and the resources in the first resource set have the same periodicity and the periodicity of the resources in the second resource set is determined by the periodicity information in the first configuration signaling for configuring the first resource set.

For example, the periodicity information is indicated by the parameter periodicity in the first configuration signaling ConfiguredGrantConfig.

In an embodiment, the second configuration signaling comprises the offset information, the resource identifier, the maximum transmission time, and the prohibit timer.

As an alternative, the second configuration signaling comprises the offset information and the resource identifier.

As an alternative, the second configuration signaling comprises the offset information.

In an embodiment, the offset information is used for determining the interval between the resources in the second resource set and the resources in the first resource set.

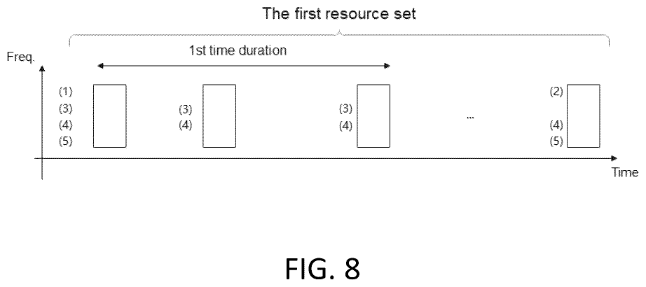

In an embodiment, one or more resources in the second resource set are located in a position with an offset or an interval prior to a resource in the first resource set. The offset is in the unit of a symbol or a slot, where the offset is the interval between the first/last symbol of the resources in the second resource set and the first/last symbol of the resources in the first resource set. In this embodiment, the resources in the first resource set may include a first (1st) resource in the resources associated with the first resource set. In this embodiment, the location of the resource in the second resource set may be a location (1) shown in FIG. 8 according to an example.

In an embodiment of the one or more resources in the second resource set being located in a position with the offset or the interval prior to the resource in the first resource set, the resource in the first resource set includes the last resource in the resources associated with the first resource set. In this embodiment, the location of the resources in the second resource set may be in a location (2) shown in FIG. 8 according to an example.

In an embodiment of the one or more resources in the second resource set being located in a position with the offset or the interval prior to the resource in the first resource set, the resources in the first resource set include a plurality of resources in the first resource set in one time duration. In this embodiment, the plurality of resources may represent all the resources in the first resource set in one time duration. In this embodiment, the location of the resources in the second resource set may be in locations (3) shown in FIG. 8 according to an example.

In an embodiment of the one or more resources in the second resource set are located in a position with the offset or the interval prior to the resource in the first resource set and the resources in the first resource set including the plurality of resources in the first resource set, the plurality of resource represents all the resources in the first resource set. In this embodiment, the location of the resources in the second resource set may be in locations (4) shown in FIG. 8 according to an example.

In an embodiment of the one or more resources in the second resource set being located in the position with the offset or the interval prior to the resource in the first resource set, the resources in the first resource set (only) include the first (1st) resource in the resources associated with the first resource set and the last resource in the resources associated with the first resource set. In this embodiment, the location of the resources in the second resource set may be in locations (5) shown in FIG. 8 according to an example.

In FIG. 8, each blank box denotes the resources in the first resource set. Note that the locations (1) to (5) have no difference in frequency domain. In addition, locations (1) to (5) are in slots different from those of the blank boxes.

In an embodiment, one or more resources in the second resource set are located in a position with an offset or an interval after the resources in the first resource set. The offset or the interval is in the unit of a symbol, a slot, or a radio frame. As an alternative, the offset is in the unit of a symbol or a slot, where the offset is the interval between the first/last symbol of the resources in the second resource set and the first/last symbol of the resources in the first resource set.

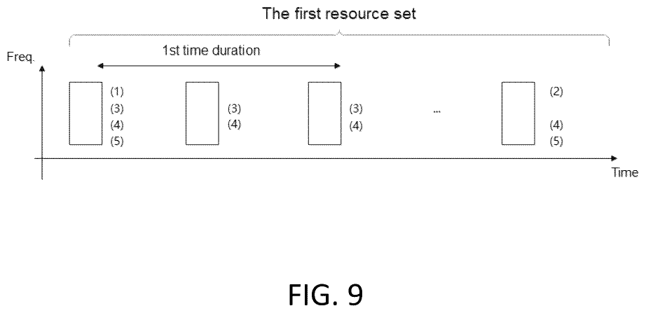

In an embodiment of the one or more resources in the second resource set being located in a position with an offset or an interval after a resource in the first resource set, the resources in the first resource set include the first (1st) resource in the resources associated with the first resource set. In this embodiment, the location of the resources in the second resource set may be in a location (1) shown in FIG. 9.

In an embodiment of the one or more resources in the second resource set being located in the position with the offset or the interval after the resources in the first resource set, the resource in the first resource set includes the last resource in the resources associated with the first resource set. In this embodiment, the location of the resources in the second resource set may be in a location (2) shown in FIG. 9 according to an example.

In an embodiment of the one or more resources in the second resource set being located in the position with the offset or the interval after the resources in the first resource set, the resources in the first resource set include a plurality of resources in the first resource set in one time duration. In this embodiment, the plurality of resources may represent all the resources in the first resource set in one time duration. Under such conditions, the location of the resources in the second resource set may be in locations (3) shown in FIG. 9 according to an example.

In an embodiment of the one or more resources in the second resource set being located in the position with the offset or the interval after the resource in the first resource set and the resources in the first resource set including the plurality of resources in the first resource set, the plurality of resource represents all the resources in the first resource set. In this case, the location of the resources in the second resource set may be in locations (4) shown in FIG. 9 according to an example.

In an embodiment of the one or more resources in the second resource set being located in the position with the offset or the interval after the resources in the first resource set, the resources in the first resource set include the first (1st) resource in the resources associated with the first resource set and the last resource in the resources associated with the first resource set According to an example of this embodiment, the location of the resources in the second resource set may be in locations (5) shown in FIG. 9 according to an example.

In FIG. 9, the blank box denotes the resources in the first resource set. Note that the locations (1) to (5) have no difference in frequency domain and the locations (1) to (5) are in different slots with the blank box.

In an embodiment, one or more resources in the second resource set are in the same slot as the resource in the first resource set, and one or more resources in the second resource set are in the position with an offset prior to the resource in the first resource set. The offset may be in the unit of a symbol, where the offset is the interval between the first/last symbol of the resources in the second resource set and the first/last symbol of the resources in the first resource set.

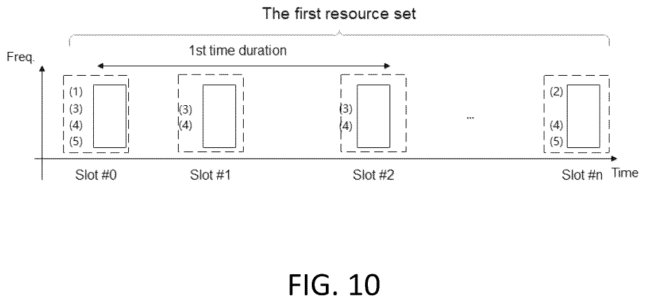

In an embodiment of the one or more resources in the second resource set being in the same slot as the resource in the first resource set and the one or more resources in the second resource set being in the position with the offset prior to the resource in the first resource set, the resources in the first resource set include the first (1st) resource in the resources associated with the first resource set. According to an example of this embodiment, the location in the slot of the resources in the second resource set may be in a location (1) shown in FIG. 10 according to an example.

In an embodiment of the one or more resources in the second resource set being in the same slot as the resource in the first resource set and the one or more resources in the second resource set being in the position with the offset prior to the resource in the first resource set, the resources in the first resource set include the last resource in the resources associated with the first resource set. According to an example of this embodiment, the location of the resources in the second resource set in the slot may be in a location (2) shown in FIG. 10 according to an example.

In an embodiment of the one or more resources in the second resource set being in the same slot as the resource in the first resource set and the one or more resources in the second resource set being in the position with the offset prior to the resource in the first resource set, the resources in the first resource set include a plurality of resources in the first resource set in one time duration.

In some cases, the plurality of resources represents all the resources in the first resource set in one time duration. According to an example of these cases, the location of the resources in the second resource set in the slot may be in locations (3) shown in FIG. 10 according to an example.

In some cases, the plurality of resource represents all the resources in the first resource set. According to an example of these cases, the location of the resources in the second resource set in the slot may be in locations (4) shown in FIG. 10 according to an example.

In an embodiment of the one or more resources in the second resource set being in the same slot as the resource in the first resource set and the one or more resources in the second resource set being in the position with the offset prior to the resource in the first resource set, the resources in the first resource set include a first resource in the resources associated with the first (1st) resource set and the last resource in the resources associated with the first resource set. According to an example in this embodiment, the location of the resources in the second resource set in the slot may be in locations (5) shown in FIG. 10 according to an example.

As shown in FIG. 10 the blank box denotes the resources in the first resource set. Note that the locations (1) to (5) have no difference in frequency domain.

In an embodiment, one or more resources in the second resource set are in the same slot as the resource in the first resource set, and one or more resources in the second resource set are in a position with an offset after the resource in the first resource set. The offset is in the unit of a symbol, where the offset is the interval between the first symbol of the resources in the second resource set and the first symbol of the resources in the first resource set.

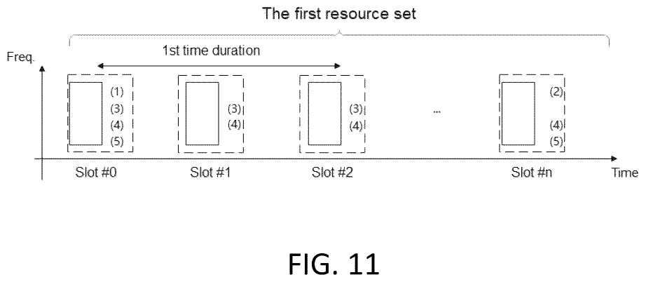

In an embodiment of the one or more resources in the second resource set being in the same slot as the resource in the first resource set and one or more resources in the second resource set being in the position with the offset after the resources in the first resource set, the resource in the first resource set includes the first (1st) resource in the resources associated with the first resource set. In this embodiment, the location of the resource in the second resource set is in a location (1) shown in FIG. 11 according to an example.

In an embodiment of the one or more resources in the second resource set being in the same slot as the resource in the first resource set and one or more resources in the second resource set being in the position with the offset after the resources in the first resource set, the resources in the first resource set include the last resource in the resources associated with the first resource set. In this embodiment, the location of the resource in the second resource set may be in a location (2) in FIG. 11 according to an example.

In an embodiment of the one or more resources in the second resource set being in the same slot as the resource in the first resource set and one or more resources in the second resource set being in the position with the offset after the resources in the first resource set, the resources in the first resource set include a plurality of resources in the first resource set in one time duration.

In some cases, the plurality of resources represents all the resources in the first resource set in one time duration. In these cases, the location of the resources in the second resource set may be in location (3) shown in FIG. 11 according to an example.

In some cases, the plurality of resources represents all the resources in the first resource set. In these cases, the location of the resources in the second resource set may be in locations (4) shown in FIG. 11 according to an example.

In an embodiment of the one or more resources in the second resource set being in the same slot as the resource in the first resource set and one or more resources in the second resource set being in the position with the offset after the resources in the first resource set, the resources in the first resource set include the first (1st) resource in the resources associated with the first resource set and the last resource in the resources associated with the first resource set. In this embodiment, the location of the resources in the second resource set may be in location (5) shown in FIG. 11 according to an example.

In FIG. 11, the blank box denotes the resources in the first resource set. Note that the locations of (1)˜(5) have no difference in frequency domain.

In an embodiment, the first configuration signaling configures the first resource set by configuring single resource in a time duration.

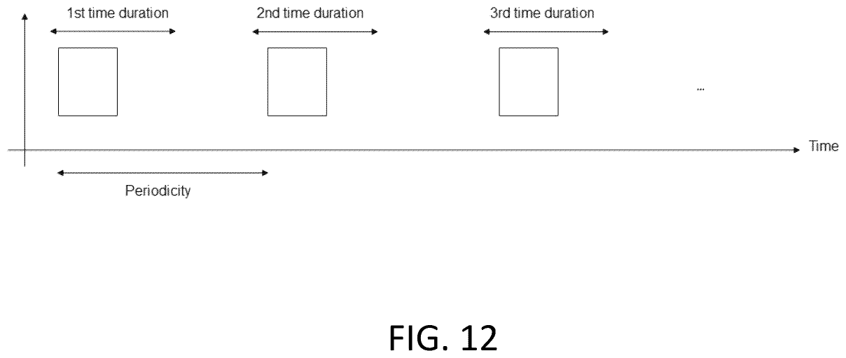

For example, the pattern of first resource set can be that depicted in FIG. 12.

In an embodiment, the first configuration signaling configures the first resource set by configuring a plurality of resources in a time duration.

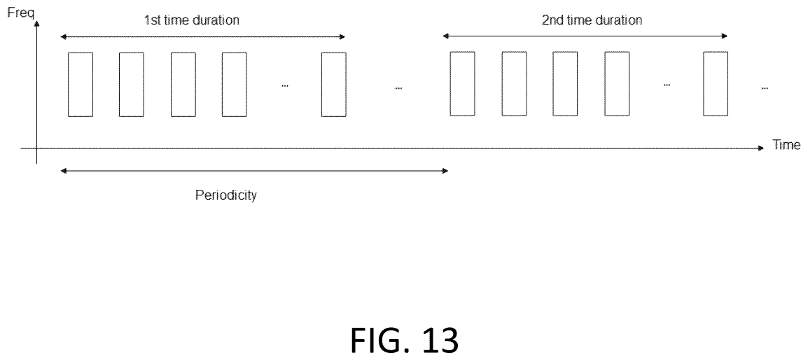

For example, the pattern of first resource set can be that depicted in FIG. 13.

In an embodiment, the plurality of resources are in a time duration

In an embodiment, the time duration is a length of symbol, a length of slot, or a length of radio frame.

In an embodiment, the time duration is determined by the first configuration signaling

In some cases, the first configuration signaling is RRC signaling ConfiguredGrantConfig.

In an embodiment, the time duration is determined by a MAC CE signaling.

In an embodiment, the time duration is determined by a DCI signaling.

In some cases, the DCI signaling is DCI format 0_0, DCI format 0_1, or DCI format 0_2, where the ‘Redundancy Version’ filed is re-interpreted as all zeros.

In some cases, the DCI signaling is DCI format 0_0, DCI format 0_1, or DCI format 0_2, where ‘HARQ Process Number’ and the ‘Redundancy Version’ filed are re-interpreted as all zeros.

In an embodiment, the first configuration signaling configures the first resource set by configuring a plurality of resources in a time duration, and the plurality of resources are determined by one CG configuration.

In some cases, the plurality of resources in a time duration belong to one CG configuration.

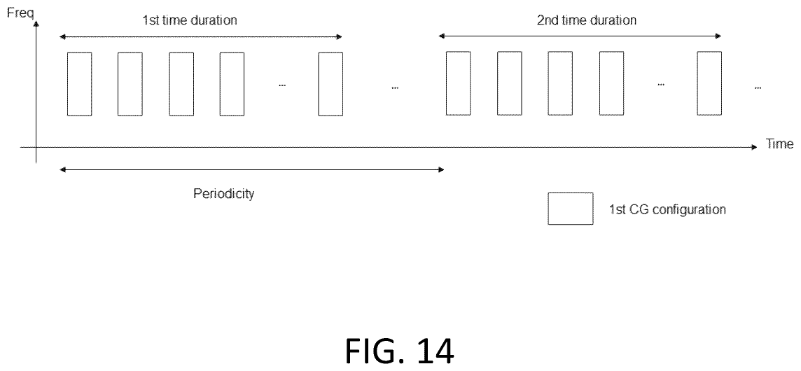

In some cases, the plurality of resources in a time duration belong to different CG configuration as shown in FIG. 14.

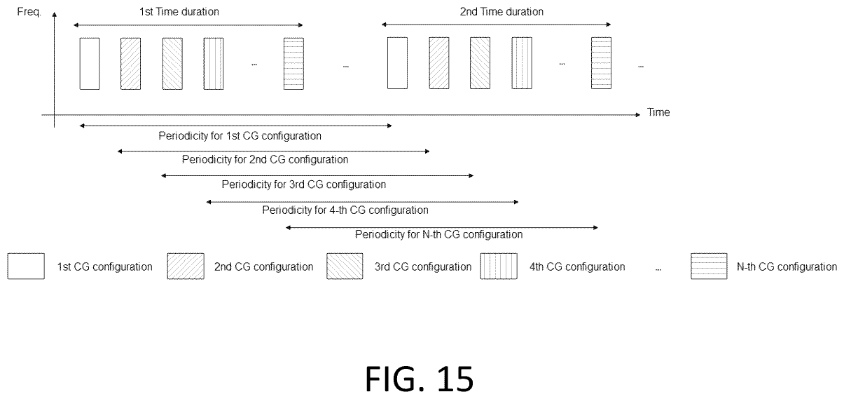

In an embodiment, each resource in a time duration belongs to corresponding CG configuration as shown in FIG. 15.

In an embodiment, the second signaling is a uplink MAC (media access control) CG (control element),

In some cases, the MAC CE is BSR, Configured grant confirm, Multiple configured grant confirm.

In an embodiment, the second signaling is a UCI (uplink control information) signaling.

In some cases, the second signaling is a scheduling request (SR).

In some cases, the second signaling is a dedicated signaling which is similar with SR.

In these cases, the second signaling is an inverse SR, which means that the function of second signaling is a resource release procedure, while SR is a resource request procedure.

In some cases, the second signaling is a dedicated signaling, which is similar with CG-UCI.

In some cases, the second signaling is a dedicated signaling which is similar with CSI report.

In an embodiment, the second signaling includes resource information, and the resource information comprises a number of resources in the first transmission resource set in one time duration.

In some cases, the resource information comprises the number of used resources in the first resource set in a time duration.

In some cases, the resource information comprises the number of unused resources in the first resource set in a time duration.

In some cases, the resource information comprises the number of valid resource in the first resource set in a time duration.

In some cases, the resource information comprises the number of invalid resource in the first resource set in a time duration.

In an embodiment, the number of resources in the first resource set is based on the time duration, time domain resource assignment, frequency domain resource assignment, MCS level and the number of layers, which are determined by gNB.

For example, the number of used resources in the first resource set can be calculated by

$${N}_{R} = \frac{{N}_{bit}}{{Q}_{m} \cdot R \cdot v \cdot {N}_{R}^{oc}} \qquad ( II )$$

where N_{bit} denotes the packet size in bit unit, Qₘ denotes the modulation order, R denotes the code rate, v denotes the number of layers and N_{R}^{oc} denotes the number of resource element in one resource.

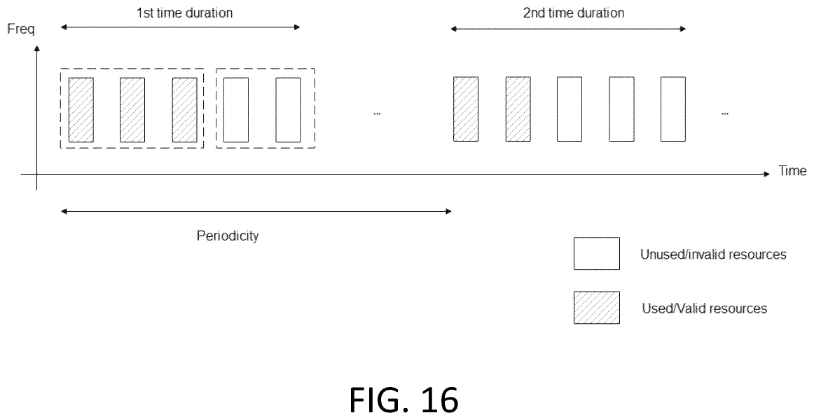

For example, in FIG. 16, there are 5 resources in each time duration. The packet transmission occupies 3 resources in the 1st time duration. In this case, the resource information is 3 for indicating that there are 3 used/valid resources in the first resource set in the 1st time duration. As an alternative, the resource information may be 2 for indicating that there are 2unused/invalid resources in the first resource set in the 1st time duration.

In an embodiment, the resource information comprises an indication for a starting resource in the first transmission resource set in one time duration.

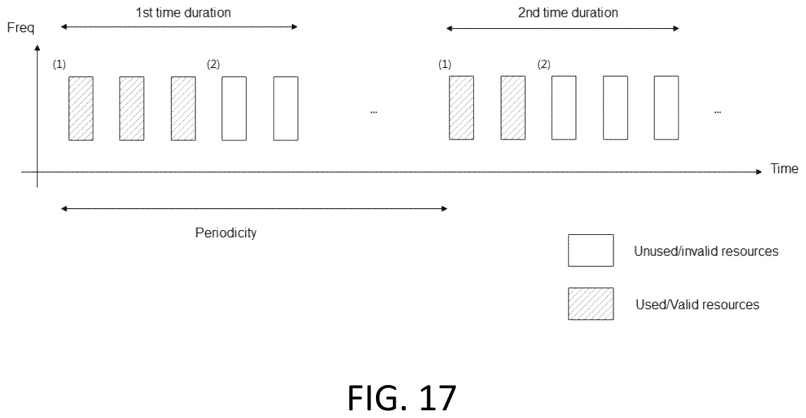

In some cases, when the resource is the first used resource in the first transmission resource set in one time duration, the resource information indicates one state (e.g., ‘0’). If gNB receives the resource information, gNB starts to decode the data in the following resources starting from the same slot as the resource information, or in following resources starting from the offset after the slot of the resource information in the first transmission resource set in the duration. It is depicted in locations (1) in FIG. 17.

In some cases, when the resource is the first unused resource in the first transmission resource set in one time duration, the resource information indicates one state (e.g., ‘0’). If gNB receives the resource information, gNB starts to skip the data decoding in the following resources starting from the same slot as the resource information, or in the following resources starting from the offset after the slot of the resource information in the first transmission resource set in the duration. It is depicted in locations (2) in FIG. 17.

In an embodiment, the resource information comprises an indication for an ending resource in the first transmission resource set in one time duration.

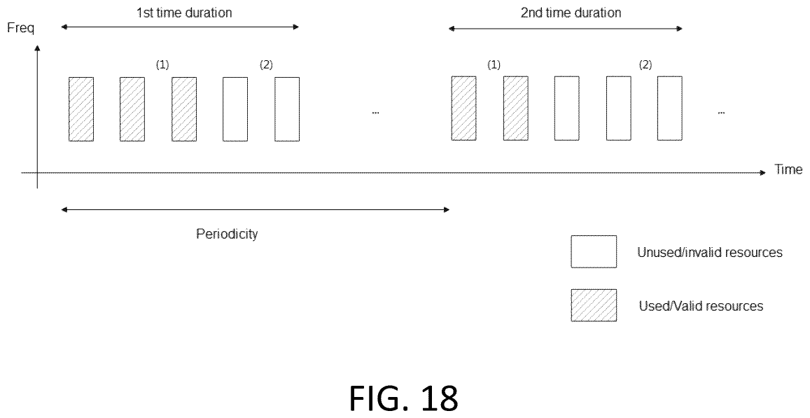

In some cases, when the resource is the last used resource in the first transmission resource set in one time duration, the resource information indicates one state (e.g., ‘1’). If gNB receives the resource information, gNB stops to decode the data in the resource in the following resources starting from the same slot as the resource information, or in the following resources starting from the offset after the slot of the resource information in the first transmission resource set in the duration. It is illustrated in location (1) in FIG. 18.

In some cases, when the resource is the last unused resource in the first transmission resource set in one time duration, the resource information indicates one state (e.g., ‘1’). If gNB receives the resource information, gNB starts to decode the data in the resource in the following resources starting from the same slot as the resource information, or in the following resources starting from the offset after the slot of the resource information in the first transmission resource set in the duration. It is illustrated in location (2) in FIG. 18.

In an embodiment, the resource information comprises an indication for a starting resource in the first transmission resource set in one time duration and an indication for an ending resource in the first transmission resource set in the time duration.

In some cases, when the resource is the first resource in the first transmission resource set in one time duration, the resource information indicates one state (e.g., ‘0’). If gNB receives the resource information, the gNB starts to decode the data in the resource in the same slot as the resource information, or in a position with an offset after the slot of the resource information in the first transmission resource set in the duration. While when the resource is the last resource in the first transmission resource set in one time duration, the resource information indicates one state (e.g., ‘1’). If gNB receives the resource information, gNB stops to decode the data in the resource in the same slot as the resource information, or in a position which is the offset after the slot of the resource information in the first transmission resource set in the duration.

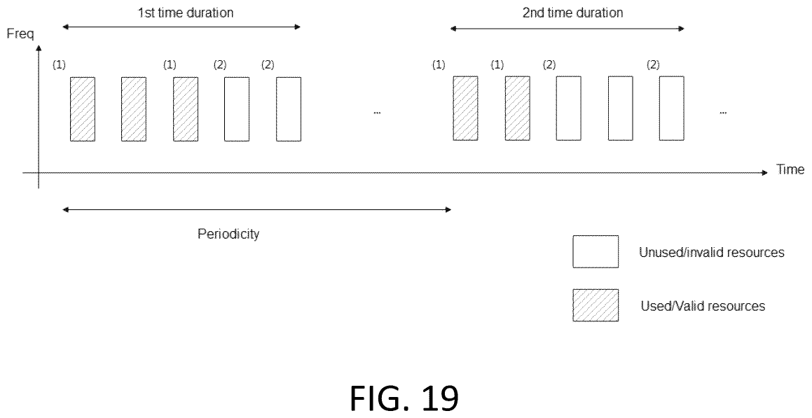

For example, as illustrated in FIG. 19, there are 5 resources in each time duration. The packet transmission occupies 3 resources in the 1st time duration, i.e. ranging from the first resource to the third resource, while the resources with no data transmission are the fourth and fifth resources. For one thing, the indication with state ‘0’ is transmitted by the UE if the UE starts to transmit data in the first resource. gNB starts to decode the data, when gNB receives the indication with state ‘0’. And the indication with state ‘1’ is transmitted by the UE if the UE transmits the last data in the third resource. gNB ends to decode data in the following resources in the first duration. It is illustrated in the location (1) in FIG. 19. For another, the indication with state ‘0’ is transmitted by the UE if the UE starts to skip data transmission in the fourth resource. gNB stops to decode the data, when gNB receives the indication with state ‘0’. And indication with state ‘1’ is transmitted by the UE if the UE stops to skip data transmission in the fifth resource. gNB starts to decode data, when gNB receives the indication with state ‘1’. It is illustrated in location (2) in FIG. 19. In an embodiment, the resource information comprises a bitmap for indicating resources in the first transmission resource set in one time duration.

In some cases, a bit is corresponding to one resource in the time duration.

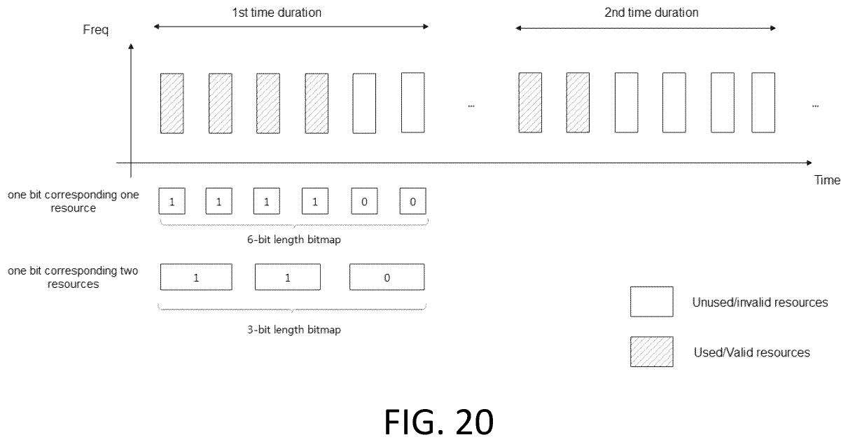

For example, as illustrated in FIG. 20, bit ‘1’ means the resource is a used resource or a valid resource in the first resource set, while bit ‘0’ means the resource is an unused resource or an invalid resource in the first resource set. Or bit ‘1’ means the resource is an unused resource or an invalid resource in the first resource set, while bit ‘0’ means the resource is a used resource or a valid resource in the first resource set.

In some cases, a bit is corresponding to a number of resources in the time duration.

For example, as illustrated in FIG. 20, bit ‘1’ means two consecutive resources are used resources or valid resource in the first resource set, while bit ‘0’ means the resources are unused resources or invalid resource in the first resource set. As an alternative, bit ‘1’ means two consecutive resources are unused resources or invalid resource in the first resource set, while bit ‘0’ means the resources are used resources or valid resource in the first resource set.

In some cases, the length of bitmap is associated with single time duration and/or the number of resources in the time duration. In addition, single bit in the bitmap may be associated with multiple resources (in the time duration).

In an embodiment, the resource information comprises a bitmap for indicating resources in the first transmission resource set in more than one (multiple) time durations.

In some cases, the length of bitmap is associated with the number of time durations and/or the time duration and/or the number of resources in the time duration In addition, single bit in the bitmap may be associated with multiple resources (in the time duration).

In an embodiment, the resource information comprises a start and length indicator value (SLIV) for the first transmission resource set in one/single time duration.

In some cases, the SLIV is calculated by

```
if (L − 1) ≤ Z / 2 then
  SLIV = Z · (L − 1) + S
else
  SLIV = Z · (Z − L + 1) + (Z − 1 − S)
```

where 0≤L≤Z−S, while Z is the number of resources in the first resource set in a time duration

In some cases, L is the number of used resources in the first resource set which is determined by equation (II), while S is the starting used resource in the first resource set.

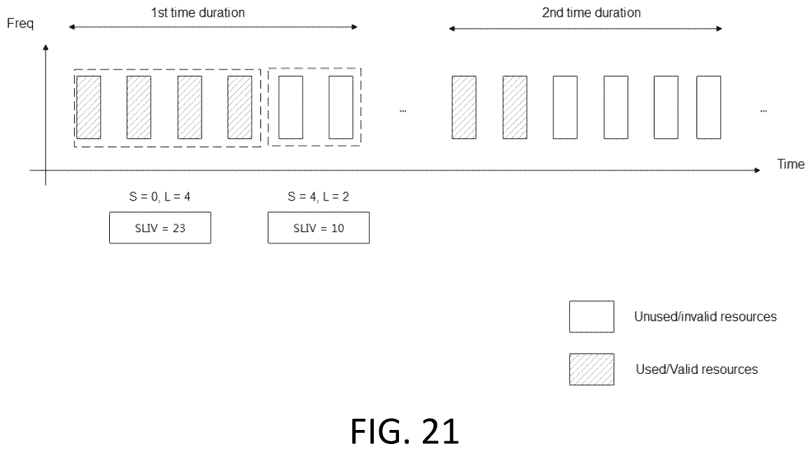

For example, as illustrated in FIG. 21, the SLIV is 23.

In some cases, L is the number of unused resources in the first resource set, while S is the starting used resource in the first resource set.

For example, as illustrated in FIG. 21, the SLIV is 10.

In an embodiment, the resource information comprises a resource block number of the last resource in the first transmission resource set in one duration.

In some cases, the resource block number includes the number of occupied resource blocks, the number of unoccupied resource blocks.

In some cases, the resource block number includes the bitmap for indicating the resource block occupation in BWP (bandwidth part), where the length of bitmap is associated with the bandwidth of BWP, and the resource block group size.

In an embodiment, the second signaling further indicates a number of consecutive resources used in the first resource set in the time duration after the second signaling is transmitted.

In an embodiment, the second signaling further indicates a number of consecutive resources used in the first resource set in the time duration prior to the second signaling is transmitted.

In an embodiment, the second signaling further indicates a number of consecutive resources used in the first resource set in current time duration when the second signaling is transmitted.

In an embodiment, the second signaling further indicates a number of consecutive resources unused in the first resource set in the time duration after the second signaling is transmitted.

In an embodiment, the second signaling further indicates a number of consecutive resources unused in the first resource set in the time duration prior to the second signaling is transmitted.

In an embodiment, the second signaling further indicates a number of consecutive resources unused in the first resource set in current time duration when the second signaling is transmitted.

In an embodiment, the second signaling further indicates a first resource used in the first resource set in the time duration after the second signaling is transmitted.

In an embodiment, the second signaling further indicates a first resource used in the first resource set in the time duration prior to the second signaling is transmitted.

In an embodiment, the second signaling further indicates a first resource used in the first resource set in current time duration when the second signaling is transmitted.

In an embodiment, the second signaling further indicates a first resource unused in the first resource set in the time duration after the second signaling is transmitted.

In an embodiment, the second signaling further indicates a first resources unused in the first resource set in the time duration prior to the second signaling is transmitted.

In an embodiment, the second signaling further indicates a first resource unused in the first resource set in current time duration when the second signaling is transmitted.

In an embodiment, the second signaling further indicates all resources used in the first resource set in the time duration after the second signaling is transmitted.

In an embodiment, the second signaling further indicates all resources used in the first resource set in the time duration prior to the second signaling is transmitted.

In an embodiment, the second signaling further indicates all resources used in the first resource set in current time duration when the second signaling is transmitted.

In an embodiment, the second signaling further indicates all resources unused in the first resource set in the time duration after the second signaling is transmitted.

In an embodiment, the second signaling further indicates all resources unused in the first resource set in the time duration prior to the second signaling is transmitted.

In an embodiment, the second signaling further indicates all resources unused in the first resource set in current time duration when the second signaling is transmitted.

In an embodiment, the second signaling is transmitted in the second transmission resource set by PUCCH.

In some cases, the PUCCH is located in a position with an offset prior to a P-th resource in the first transmission resource set in one time duration, wherein P is a positive integer, and wherein offset is in the unit of a symbol/slot, and the offset is the interval between the first/last symbol of the resources in the second resource set and the first/last symbol of the resources in the first resource set.

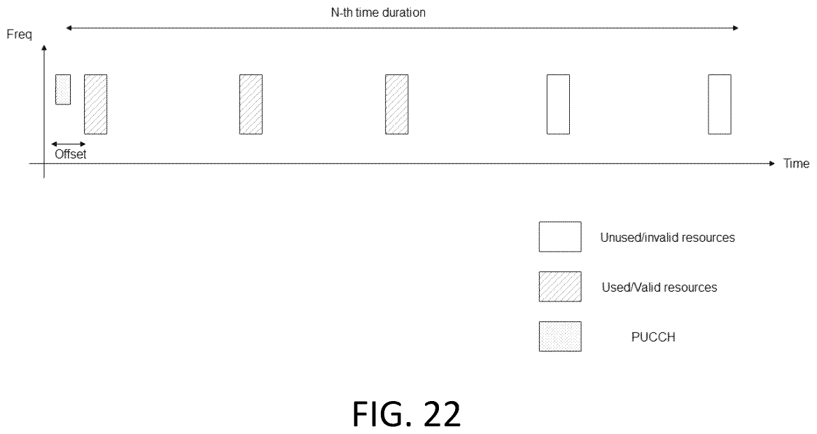

In an embodiment, the P-th resource includes a first resource in the first transmission resource set in one time duration (see, e.g., FIG. 22).

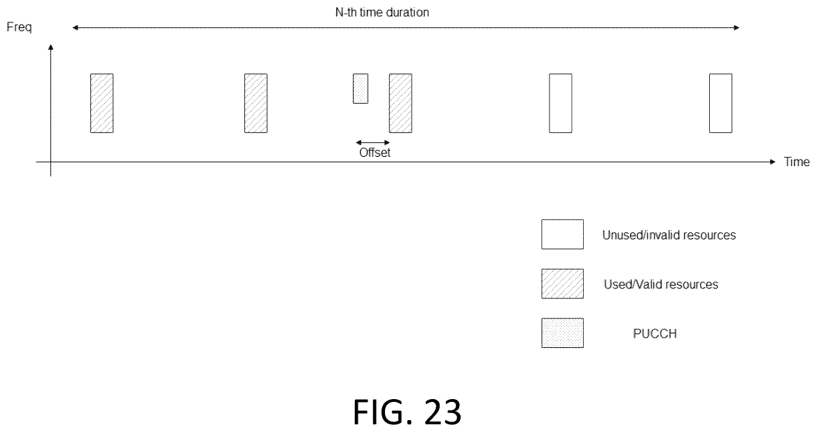

As an alternative, the P-th resource includes a last resource in the first transmission resource set in one time duration (see, e.g., FIG. 23).

As an alternative, the P-th resource includes a pre-defined resource in the first transmission resource set in one time duration.

As an alternative, the P-th resource includes a random resource in the first transmission resource set in one time duration.

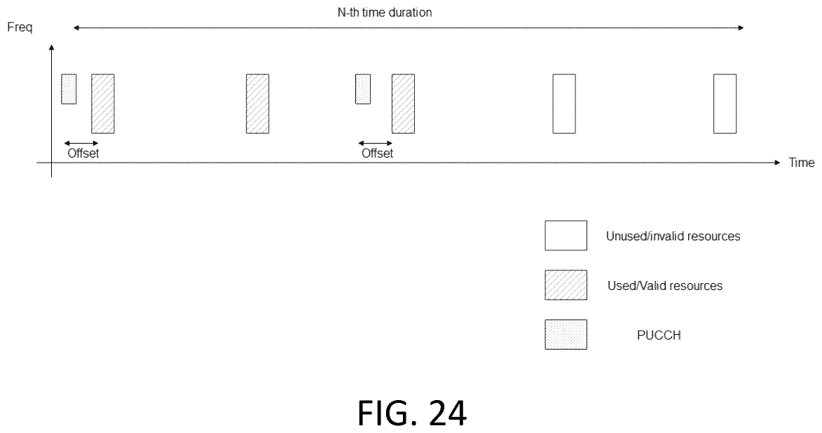

In some cases, the PUCCH is located in a position with an offset prior to the first (1st) resource in the first transmission resource set and the last resource in the first transmission resource set in one time duration. wherein offset is in the unit of a symbol/slot, and the offset is the interval between the first/last symbol of the resources in the second resource set and the first/last symbol of the resources in the first resource set (see, e.g., FIG. 24).

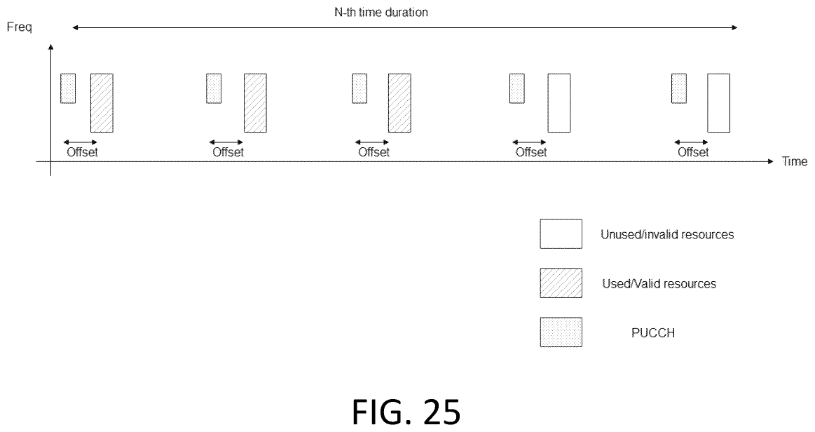

In some cases, the PUCCH is located in a position with an offset prior to each resource in the first transmission resource set in one time duration (see, e.g., FIG. 25).

In some cases, the PUCCH is located in a position with an offset after a P-th resource in the first transmission resource set in one time duration, wherein P is a positive integer, and wherein offset is in the unit of a symbol/slot, and the offset is the interval between the first/last symbol of the resources in the second resource set and the first/last symbol of the resources in the first resource set.

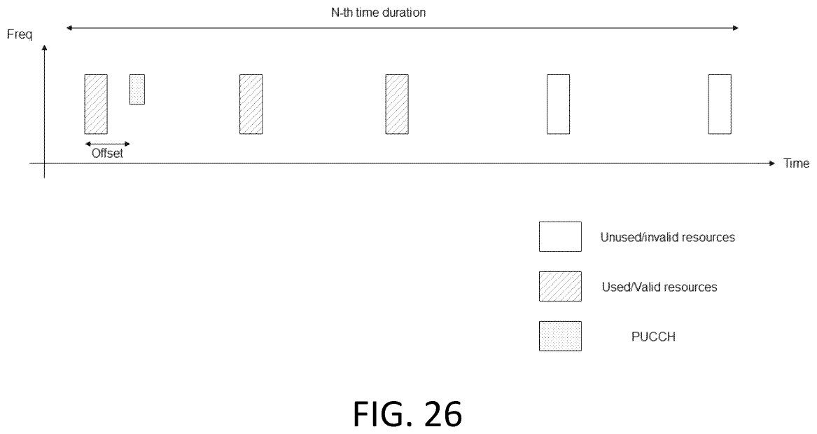

In an embodiment, the P-th resource includes a first resource in the first transmission resource set in one time duration (see, e.g., FIG. 26).

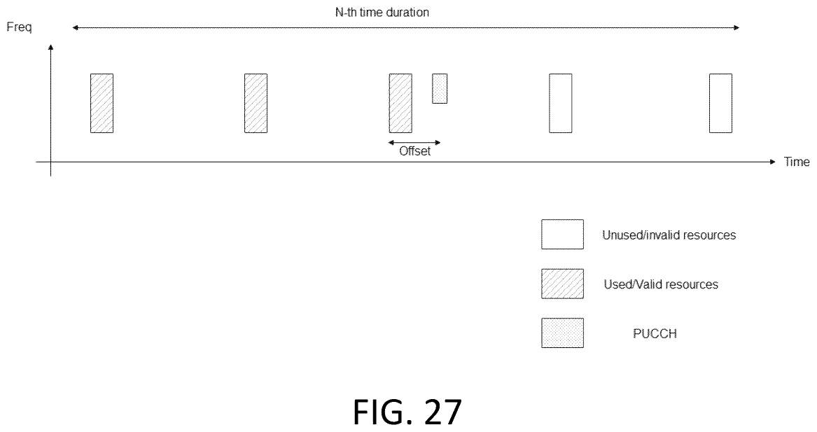

As an alternative, the P-th resource includes a last resource in the first transmission resource set in one time duration (see, e.g., FIG. 27).

As an alternative, the P-th resource includes a pre-defined resource in the first transmission resource set in one time duration.

As an alternative, the P-th resource includes a random resource in the first transmission resource set in one time duration.

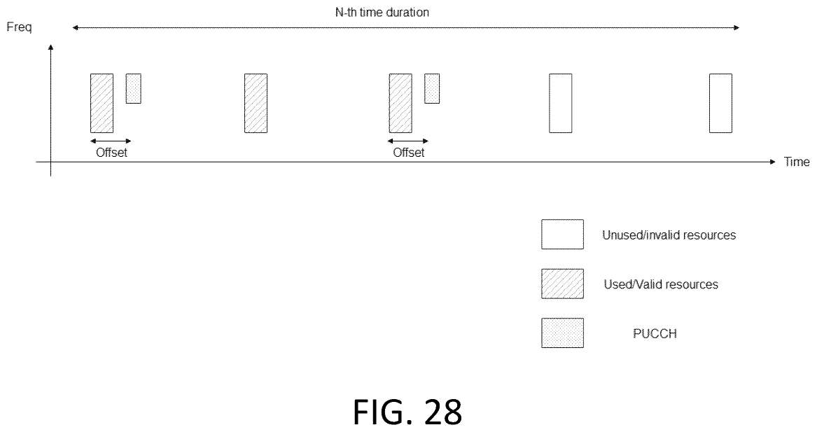

In some cases, the PUCCH is located in a position with an offset after the first (1st) resource in the first transmission resource set and the last resource in the first transmission resource set in one time duration. wherein the offset is in the unit of a symbol/slot, and the offset is the interval between the first/last symbol of the resources in the second resource set and the first/last symbol of the resources in the first resource set (see, e.g., FIG. 28).

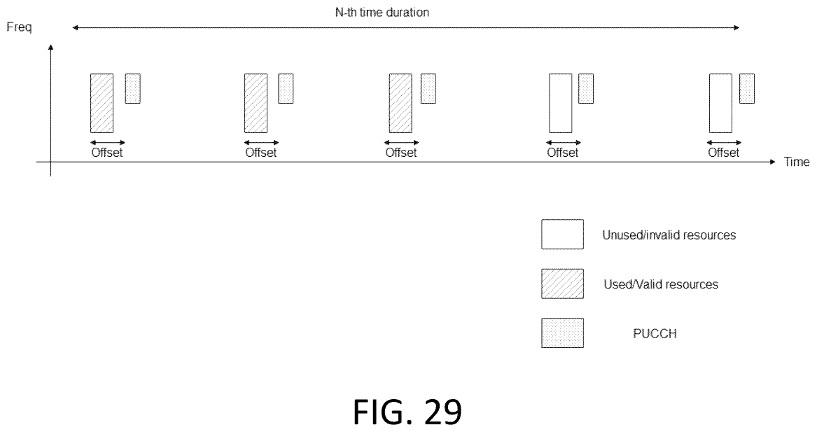

In some cases, the PUCCH is located in a position with an offset after each resource in the first transmission resource set in one time duration (see, e.g., FIG. 29).

In an embodiment, resource information in the second signaling transmitted on the PUCCH is determined by cyclic shift information.

In some cases, through PUCCH format 0, PUCCH format 1, PUCCH format 3 or PUCCH format 4, the sequence with different cyclic shift information determines different resource information, including, e.g., different the number of resources in the first transmission resource set, the indication for a starting and/or ending resource in the first transmission resource set, different SLIVs in the first transmission resource set, where the sequence is Low-PAPR sequence generation type 1.

For example, the value of cyclic shift α is determined by m₀ and m_{cs}, where m₀ is determined by high layer parameter ‘initialCyclicShift’, and the m_{cs} can represent different resource information, where m₀ and m_{cs} is not less than 0 and not larger than 11.

As an alternative, resource information is the indication for a starting and/or ending resource in the first transmission resource set, m_{cs} is 0 represents a starting resource in the first transmission resource set, while m_{cs} is 6 represents an ending resource in the first transmission resource set.

As an alternative, resource information is the indication for the number of resources in the first transmission resource set, m_{cs} ranging from 0 to 11 corresponds to different the number of resources. For example, ‘0’ corresponds to length 4, ‘1’ corresponds to length 6, and so on.

As an alternative, resource information is the indication for the number of resources in the first transmission resource set, m_{cs} ranging from 0 to 11 corresponds to different SLIVs in the first transmission resource set. For example, ‘0’ corresponds to SLIV=2, ‘1’ corresponds to length 10, and so on.

In an embodiment, resource information in the second signaling transmitted on the PUCCH is determined by an orthogonal cover code.

In some cases, through PUCCH format 1, PUCCH format 3 or PUCCH format 4, the sequence with different orthogonal cover code determines different resource information, including, e.g., different numbers of resources in the first transmission resource set, the indication for a starting or ending resource in the first transmission resource set, different SLIVs in the first transmission resource set, where the sequence is Low-PAPR sequence generation type 1.

For example, the indices of different orthogonal cover codes are determined by a high layer parameter ‘timeDomainOCC’, where indices are ranging from 0 to 6.

As an alternative, the resource information is the indication for a starting resource and/or ending resource in the first transmission resource set. For example, the index ‘0’ represents one orthogonal cover code for the starting resource in the first transmission resource set and the index ‘1’ represents another orthogonal cover code for an ending resource in the first transmission resource set.

As an alternative, the resource information is the indication for the number of resources in the first transmission resource set, wherein the indices ranging from 0 to 6 correspond to different orthogonal cover code for different the number of resources. For example, index ‘0’ corresponds to one orthogonal cover code for length 4, index ‘1’ corresponds to another orthogonal cover code for length 6, and so on.

As an alternative, the resource information is the indication for the number of resources in the first transmission resource set, wherein the indices ranging from 0 to 6 correspond to different orthogonal cover codes for different SLIVs in the first transmission resource set. For example, index ‘0’ corresponds to one orthogonal cover code for SLIV=2, index ‘1’ corresponds to another orthogonal cover code for length 10, and so on.

In an embodiment, resource information in the second signaling transmitted on the PUCCH is determined by a high layer parameter.

In some embodiment, if the high layer parameter is configured, the SR is re-interpreted as the second signaling, indicating the indication for starting resource and/or last resource of the first transmission resource set.

In an embodiment, the second signaling is transmitted in the second transmission resource set by PUSCH.

In some cases, the PUSCH includes the Q-th resource of the first transmission resource set in one time duration.

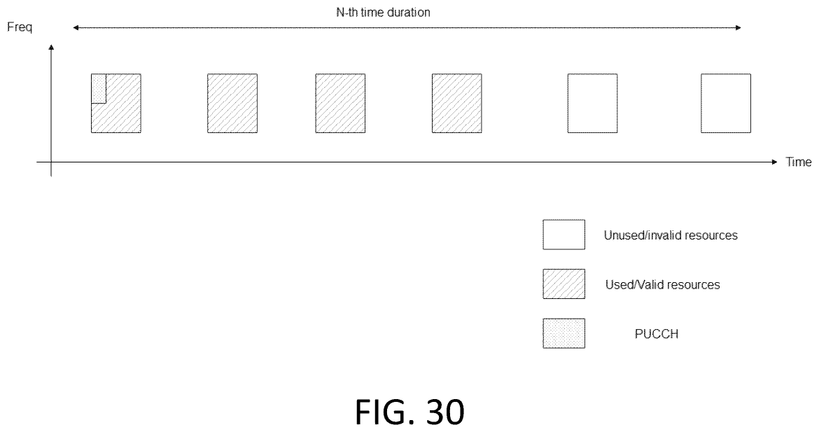

In an embodiment, the Q-th resource is the first resource of the first transmission resource set in one time duration (see, e.g., FIG. 30).

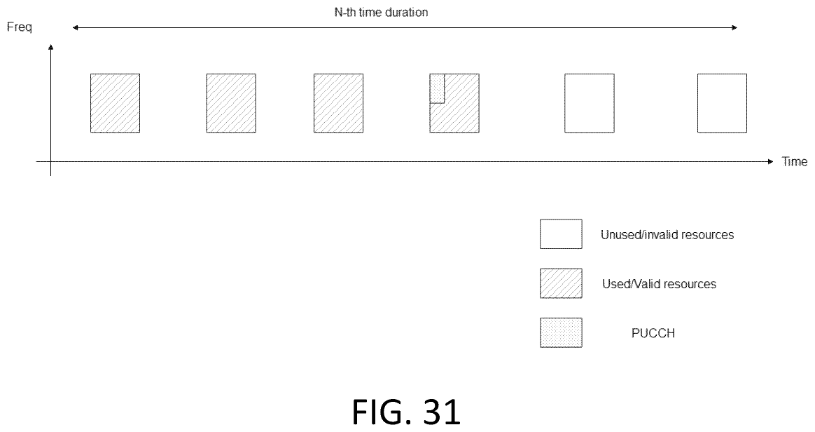

As an alternative, the Q-th resource is the last resource of the first transmission resource set in one time duration (see, e.g., FIG. 31).

As an alternative, the Q-th resource is the pre-defined resource of the first transmission resource set in one time duration.

As an alternative, the Q-th resource is the a random resource of the first transmission resource set in one time duration.

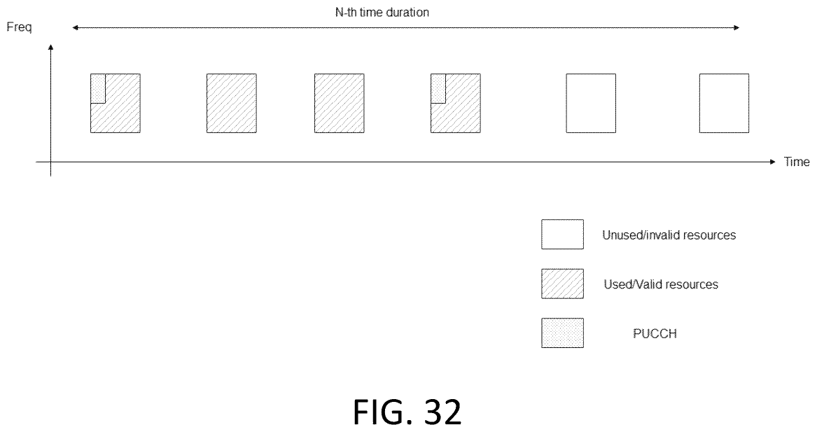

As an alternative, the Q-th resource is the first resource of the first (1st) transmission resource set and the last resource of the first transmission resource set in one time duration (see, e.g., FIG. 32).

In some cases, the PUSCH includes the R-th resource of the first resource set in one time duration.

In an embodiment, the Q-th resource is the first resource of the first resource set in one time duration.

As an alternative, the Q-th resource is the last resource of the first resource set in one time duration.

As an alternative, the Q-th resource is the pre-defined resource of the first resource set in one time duration.

As an alternative, the Q-th resource is a random resource of the first resource set in one time duration.

In some cases, a plurality of resources of the first transmission resource in one time duration.

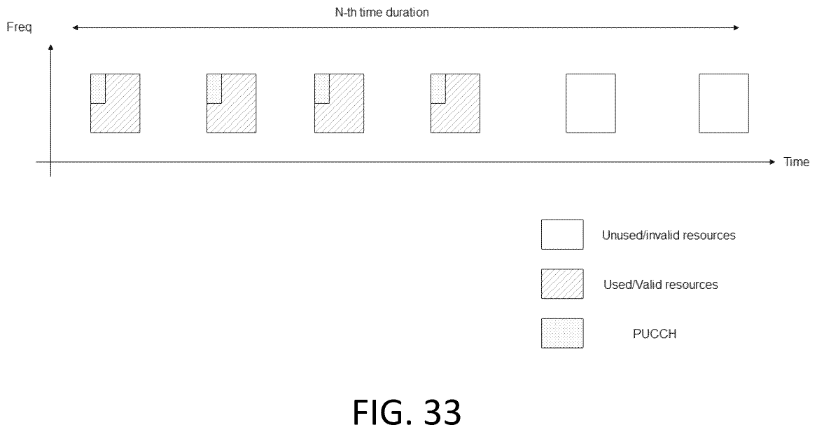

In an embodiment, the plurality of resources includes all the resources of the first transmission resource in one time duration (see, e.g., FIG. 33).

In some cases, a plurality of resources of the first resource in one time duration.

In an embodiment, the plurality of resources includes all the resources of the first resource in one time duration.

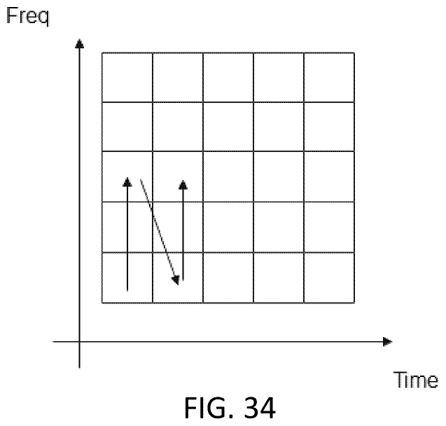

In an embodiment shown in FIG. 34, the second signaling is transmitted in the second transmission resource set by the PUSCH, resource elements of the PUSCH start at a starting point and according to first an order in a frequency domain and then an order in time domain.

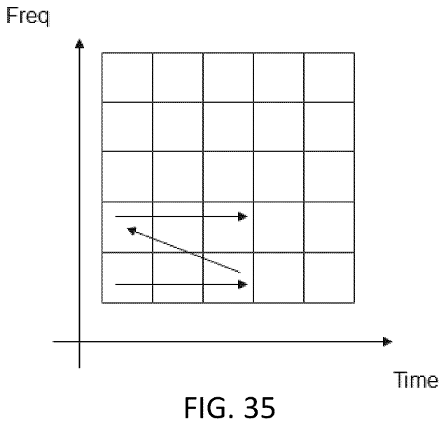

In an embodiment shown in FIG. 35, the second signaling is transmitted in the second transmission resource set by the PUSCH, resource elements of the PUSCH start at a starting point and according to first an order in time domain and then an order in frequency domain.

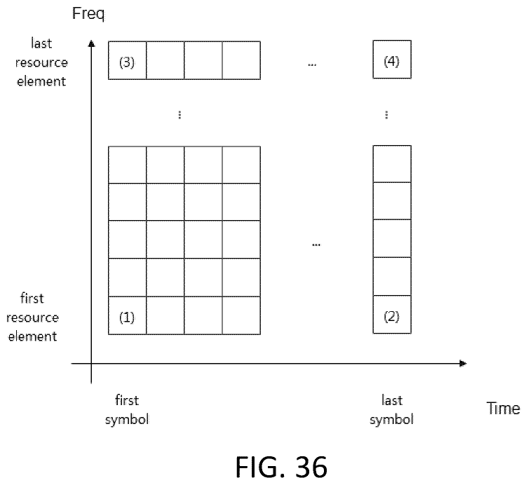

In an embodiment, the starting point is the first resource element in the first symbol, as illustrated in a location (1) shown in FIG. 36.

In an embodiment, the starting point is the first resource element in the last symbol, as illustrated in a location (2) shown in FIG. 36.

In an embodiment, the starting point is the last resource element in the first symbol,, as illustrated in a location (3) shown in FIG. 36.

In an embodiment, the starting point is the last resource element in the last symbol in the PUSCH, as illustrated in a location (4) shown in FIG. 36.

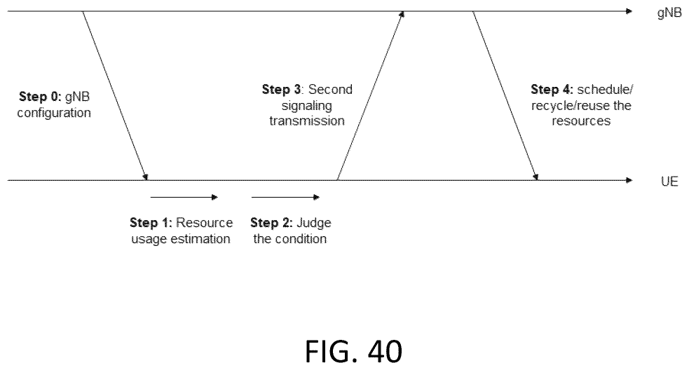

In an embodiment, the procedure of the second signaling transmission and processing is summarized in FIG. 40:

Step 0: The gNB configures the first resource set by the first configuration signaling, including the parameters of the first configuration signaling such as, MCS level, time domain resource allocation, frequency domain resource allocation, the number of layers and so on.

Step 1: The UE estimates the resource usages by equation (II).

Step 2: The UE determines whether to transmit the second signaling or not based on condition(s) associated with the second signaling transmission. For example, if the number of resources in the first transmission resource set in a time duration is less than the number of resources in the first resource set in the time duration, the UE transmits the second signaling.

Step 3: The UE transmits the second signaling via a UCI signaling and/or a MAC CE signaling.

Step 4: The gNB schedules/recycles/re-uses unused resources (indicated by the second signaling) after receiving the second signaling (e.g., resource release reporting).

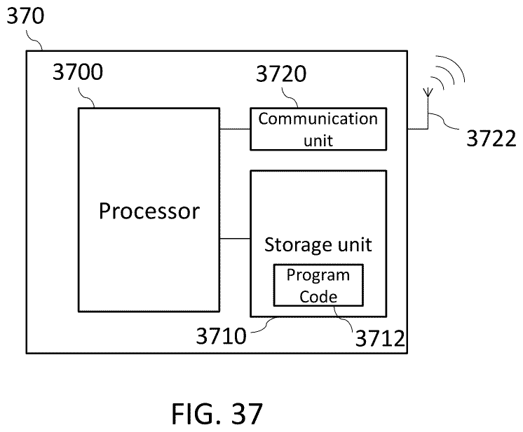

FIG. 37 relates to a schematic diagram of a wireless terminal 370 according to an embodiment of the present disclosure. The wireless terminal 370 may be a user equipment (UE), a mobile phone, a laptop, a tablet computer, an electronic book or a portable computer system and is not limited herein. The wireless terminal 370 may include a processor 3700 such as a microprocessor or Application Specific Integrated Circuit (ASIC), a storage unit 3710 and a communication unit 3720. The storage unit 3710 may be any data storage device that stores a program code 3712, which is accessed and executed by the processor 3700. Embodiments of the storage unit 3710 include but are not limited to a subscriber identity module (SIM), read-only memory (ROM), flash memory, random-access memory (RAM), hard-disk, and optical data storage device. The communication unit 3720 may a transceiver and is used to transmit and receive signals (e.g., messages or packets) according to processing results of the processor 3700. In an embodiment, the communication unit 3720 transmits and receives the signals via at least one antenna 3722 shown in FIG. 37.

In an embodiment, the storage unit 3710 and the program code 3712 may be omitted and the processor 3700 may include a storage unit with stored program code.

The processor 3700 may implement any one of the steps in exemplified embodiments on the wireless terminal 370, e.g., by executing the program code 3712.

The communication unit 3720 may be a transceiver. The communication unit 3720 may as an alternative or in addition be combining a transmitting unit and a receiving unit configured to transmit and to receive, respectively, signals to and from a wireless network node (e.g., a base station).

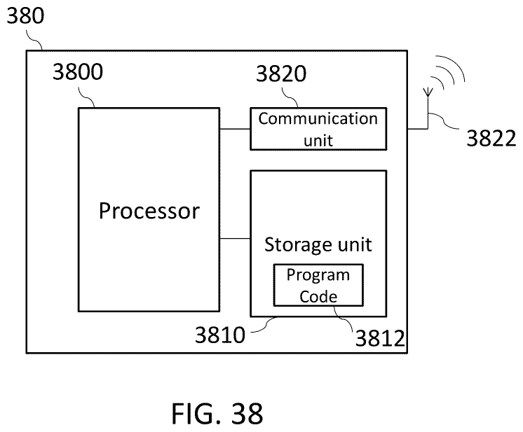

FIG. 38 relates to a schematic diagram of a wireless network node 380 according to an embodiment of the present disclosure. The wireless network node 380 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 380 may comprise (perform) at least one network function such as an access and mobility management function (AMF), a session management function (SMF), a user place function (UPF), a policy control function (PCF), an application function (AF), etc. The wireless network node 380 may include a processor 3800 such as a microprocessor or ASIC, a storage unit 3810 and a communication unit 3820. The storage unit 3810 may be any data storage device that stores a program code 3812, which is accessed and executed by the processor 3800. Examples of the storage unit 3810 include but are not limited to a SIM, ROM, flash memory, RAM, hard-disk, and optical data storage device. The communication unit 3820 may be a transceiver and is used to transmit and receive signals (e.g., messages or packets) according to processing results of the processor 3800. In an example, the communication unit 3820 transmits and receives the signals via at least one antenna 3822 shown in FIG. 38.

In an embodiment, the storage unit 3810 and the program code 3812 may be omitted. The processor 3800 may include a storage unit with stored program code.

The processor 3800 may implement any steps described in exemplified embodiments on the wireless network node 380, e.g., via executing the program code 3812.

The communication unit 3820 may be a transceiver. The communication unit 3820 may as an alternative or in addition be combining a transmitting unit and a receiving unit configured to transmit and to receive, respectively, signals to and from a wireless terminal (e.g., a user equipment or another wireless network node).

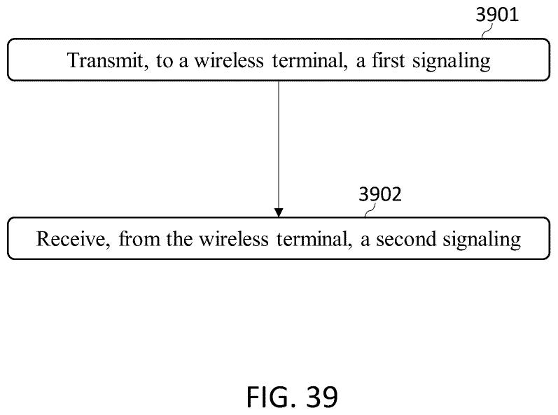

FIG. 39 shows a flowchart of a method according to an embodiment of the present disclosure. The method may be used in a wireless network node and comprises the following steps:
Step 3901: Transmit, to a wireless terminal, a first signaling.
Step 3902: Receive, from the wireless terminal, a second signaling.

In FIG. 39, the wireless network node transmits a first signaling, comprising a first configuration signaling to a wireless terminal (e.g., UE). The first configuration signaling is used to configure a first resource set for a CG transmission. In this embodiment, the wireless network node receives, from the wireless terminal, a second signaling associated with a first transmission resource set on a second transmission resource set. Based on the second signaling, the wireless terminal may reuse certain resources in the first resource set for other purposes.

More details of the method shown in FIG. 39 can be referred to those of the method shown in FIG. 4.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

We claim:

1. A wireless communication method for use in a wireless terminal, the wireless communication method comprising:
receiving, from a wireless network node, a first signaling comprising a first configuration signaling, wherein the first configuration signaling is used to configure a first resource set for a configured grant (CG) transmission, and
transmitting, to the wireless network node, a second signaling comprising a bitmap for indicating resources in the first resource set in one time duration on each resource in a first transmission resource set,
wherein the first resource set includes the first transmission resource set,
wherein the first resource transmission resource set includes one or more resources used for the CG transmission in the first resource set in one time duration.

2. The wireless communication method of claim 1, wherein the first transmission resource set is a part of first resource set or a subset of first resource set.

3. The wireless communication method of claims 1, wherein a bit is corresponding to one resource in the time duration, bit ‘1’ means the resource is an unused resource in the first resource set, while bit ‘0’ means the resource is a unused resource in the first resource set, and wherein the length of bitmap is associated with the number of resources in the time duration.

4. The wireless communication method of claim 1, wherein the second signaling is associated with one time duration, wherein the one time duration starts after the second signaling is transmitted.

5. The wireless communication method of claim 1, wherein the second signaling is transmitted in a second transmission resource set.

6. The wireless communication method of claim 5, wherein the second signaling includes at least one of an uplink MAC CE or an uplink control information (UCI) signaling.

7. The wireless communication method of claim 1, wherein the second transmission resource set is included in the second resource set and the second resource set is configured by a second configuration signaling in the first signaling.

8. The wireless communication method of claim 5, wherein the second configuration signaling comprises at least one of periodicity information for the second resource set, offset information for the second resource set, a resource identifier for the second resource set, a maximum transmission time for the second signaling, or a prohibit timer for the second signaling.

9. The wireless communication method of claim 4, wherein resources in the second resource set are periodic,
wherein a periodicity of the resources in the second resource set is configured by periodicity information in the second configuration signaling,
wherein a periodicity of the resources in the second resource set is the same with a periodicity of the resources in the first resource set.

10. The wireless communication method of claim 5, wherein the second resource set is associated with the first resource set.

11. The wireless communication method of claim 5,
wherein one or more resources in the second resource set are located an offset before or after a resource in the first resource set, and
wherein a unit of the offset is a slot, a symbol or a radio frame.

12. The wireless communication method of claim 5, wherein one or more resources in the second resource set are in the same slot as a resource in the first resource set,
wherein one or more resources in the second resource set are an offset before or after the resource in the first resource set, and
wherein a unit of the offset is a symbol.

13. A wireless communication method for use in a wireless network node, the method comprising:
transmitting, to a wireless terminal, a first signaling comprising a first configuration signaling, wherein the first configuration signaling is used to configure a first resource set for a configured grant (CG) transmission, and
receiving, from the wireless terminal, a second signaling associated with a first transmission resource set on a second transmission resource set,
wherein the first resource set includes the first transmission resource set.

14. The wireless communication method of claim 13, wherein the second signaling includes at least one of an uplink MAC CE or an uplink control information (UCI) signaling.

15. The wireless communication method of claim 13, wherein the second signaling is transmitted in a second transmission resource set by a PUCCH, and
wherein the PUCCH is located an offset before or after a resource in the first transmission resource set,
wherein a unit of the offset is a slot, a symbol or a radio frame.

16. The wireless communication method of claim 13, wherein the second signaling is
transmitted in a second transmission resource set by a PUCCH, and
wherein the PUCCH is located in the same slot as a resource in the first transmission resource set, and an offset before or after a resource in first transmission resource set,
wherein a unit of the offset is a symbol.

17. The wireless communication method of claim 13, wherein the second signaling is transmitted in the second transmission resource set by a PUSCH,
wherein:
resource elements of the PUSCH start at a starting point and according to first an order in a frequency domain and then an order in time domain, or
resource elements of the PUSCH start at a starting point and according to first an order in time domain and then an order in frequency domain.

18. The wireless communication method of claim 13, wherein the second signaling is transmitted in the second transmission resource set by a PUSCH, and
wherein a starting point of the PUSCH is determined by at least one of the first resource element in the first symbol, the first resource element in the last symbol, the last resource element in the first symbol or the last resource element in the last symbol in the PUSCH.

19. A wireless terminal, comprising:
a communication unit, configured to:
receive, from a wireless network node, a first signaling comprising a first configuration signaling, wherein the first configuration signaling is used to configure a first resource set for a configured grant (CG) transmission, and
transmit, to the wireless network node, a second signaling comprising a bitmap for indicating resources in the first resource set in one time duration on each resource in a first transmission resource set,
wherein the first resource set includes the first transmission resource set,
wherein the first resource transmission resource set includes one or more resources used for the CG transmission in the first resource set in one time duration.

20. The wireless terminal of claim 19, wherein the first transmission resource set is a part of the first resource set or a subset of the first resource set.
